(19) United States
(12) Patent Application Publication
(10) Pub. No.: US 2019/0276338 A1
(43) Pub. Date: Sep. 12, 2019

(54) COMBINED CENTRIFUGE AND DYNAMIC HEAT GENERATOR FOR PRODUCING DRINKING WATER

(71) Applicant: CLOUDBURST SOLUTIONS, LLC, Peaster, TX (US)

(72) Inventor: Edwin E. WILSON, Colleyville, TX (US)

(21) Appl. No.: 16/320,337

(22) PCT Filed: Jul. 27, 2017
(86) PCT No.: PCT/US2017/044107

§ 371 Date: Jan. 24, 2019

Related U.S. Application Data
(60) Provisional application No. 62/367,633, filed on Jul. 27, 2016.
(60) Provisional application No. 62/380,511, filed on Aug. 29, 2016.

(51) Int. Cl. C02F 1/38; B04B 5/10

(52) U.S. Cl. CPC C02F 1/38; C02F 1/16; B04B 5/10

(57) ABSTRACT

A water treatment apparatus including a cylindrical body; a centrifuge chamber and a heating chamber, both within the cylindrical body; an externally powered central shaft passing through the cylindrical body, the centrifuge chamber and the heating chamber; a centrifuge within the centrifuge chamber mounted on the central shaft and configured to rotate on the central shaft; at least one rotating disc within the heating chamber, the at least one rotating disc rotatably mounted on the shaft; an inlet operably connectable to a source of water for treatment, the inlet configured to feed water into the centrifuge chamber; a pitot tube in fluid communication with the centrifuge chamber and the heating chamber; and an exit valve in fluid communication with the heating chamber configured so that purified water exits via the exit valve. In some embodiments, each rotating disc is flanked by one or more stationary disc.

### TECHNICAL FIELD

The present invention relates to the field of water purification. More specifically, the present invention relates to a relatively small and simple apparatus for removing impurities from and disinfecting and/or sterilizing raw freshwater that may contain suspended solids and microorganisms.

### BACKGROUND

In many third world countries and in disaster events, raw freshwater is available but it needs to be treated to make it drinkable and aesthetically acceptable. This is usually accomplished by removing suspended solids, silt, and biological material and killing pathogens.

Current treatment methods consist of boiling, slow filtering with sand or bio sand, filtering with membranes, addition of flocculants and addition of chemicals such as chlorine.

### SUMMARY

The disclosed method and apparatus kills pathogens with elevated temperature and pressure while removing suspended solids such as silt and organic material by use of a centrifuge and a dynamic heat generator contained within a single apparatus and operated by a single internal shaft operated by an external prime mover.

In summary, the present invention relates to a water treatment apparatus comprising:

a cylindrical body;

a longitudinally extending centrifuge chamber within the cylindrical body;

a longitudinally extending heating chamber within the cylindrical body;

an externally powered, longitudinally extending, radially centrally located shaft passing through the cylindrical body, and passing through the centrifuge chamber and the heating chamber;

a centrifuge within the centrifuge chamber mounted on the central shaft and configured to centrifugally rotate on the central shaft;

at least one rotating disc within the heating chamber, each of the at least one rotating disc mounted on the shaft;

an inlet operably connectable to a source of water for treatment, the inlet configured to feed water into the centrifuge chamber;

a pitot tube in fluid communication with the centrifuge chamber and the heating chamber;

an exit valve in fluid communication with the heating chamber,

wherein the water treatment apparatus is configured to receive feed water into the centrifuge chamber, to operate the centrifuge to remove solids suspended in the feed water, to pass centrifuged water via the pitot tube into the heating chamber, to dynamically heat the centrifuged water to a selected temperature and pressure, and to release purified water from the heating chamber through the exit valve.

In one embodiment, the centrifuge section comprises three internal sections, including an inlet section, a centrifuge section, and an exit section. In one embodiment, the centrifuge section further comprises passages providing fluid communication between the inlet section, the centrifuge section and the exit section.

In one embodiment, the centrifuge section comprises openings in an outer peripheral portion of the centrifuge through which solids may pass. In one embodiment, the centrifuge section further comprises a portion in which solids may be collected.

In one embodiment, the pitot tube comprises a check valve.

In one embodiment, the heating section comprises from 1 to about 200 rotating discs. In one embodiment, the heating section comprises from 1 to 80, or 2 to about 20, or 5 to about 17, or from 1 to 10, or from 1 to 5, rotating discs. In one embodiment, each rotating disc is flanked by a stationary disc on one or both sides.

In one embodiment, the central shaft is rotated by an external power source.

In one embodiment, the apparatus comprises a heat exchanger for preheating the feed water prior to the water being fed into the inlet.

In one embodiment, the apparatus comprises an internal combustion engine which is operatively connected to rotate the central shaft. In one embodiment, exhaust from the internal combustion engine operatively communicates with a heat exchanger to heat the feed water prior to its entry into the centrifuge chamber, and in another embodiment may be directed to a jacket surrounding the heating section or a part thereof.

### DRAWINGS

The annexed drawings are intended to provide an exemplary, non-limiting depiction of various specific embodiments of a water purification apparatus and to demonstrate the disclosed process, for the purpose of providing a better understanding of the invention, and are not intended to be limiting in any way. In the annexed drawings, like parts and features may have like reference numbers, except that the reference numbers used in FIG. 1 do not correspond to the reference numbers used in FIG. 2-5.

FIG. 1 is a cross-sectional view of an apparatus in accordance with one embodiment of the present invention.

FIG. 2 is a cross-sectional view of an apparatus in accordance with another embodiment of the present invention.

FIG. 3 is a cross-sectional view of an apparatus in accordance with still another embodiment of the present invention.

FIG. 4 is a cross-sectional view of an apparatus in accordance with yet another embodiment of the present invention.

FIG. 5 is a cross-sectional view of an apparatus in accordance with yet another embodiment of the present invention.

It should be appreciated that for simplicity and clarity of illustration, elements shown in the Figures have not necessarily been drawn to scale. For example, the dimensions of some of the elements may be exaggerated relative to each other for clarity. Further, where considered appropriate and except as noted, reference numerals have been repeated among the Figures to indicate corresponding elements.

Furthermore, it should be appreciated that the structures and process steps described herein may not form a complete process flow for producing purified water. For example, the prime mover may be an electric motor, a gasoline or diesel engine, or some other source of rotational energy. Similarly, the raw water source can vary, and may or may not require a pump as described herein. The present invention can be practiced in conjunction with apparatus and processing techniques currently used in the art, and only so much of the commonly practiced process steps are included as are necessary for an understanding of the present invention.

### DETAILED DESCRIPTION

The present invention provides a solution to the problems of the prior art, and provides a rather simple system that provides the capability of producing potable water from water that would not be considered potable, due to a high content of suspended solids and/or an unacceptable content of biological pathogens. The present invention further provides a high level of reliability and ease of use of the water purification unit that can provide purified water to the user in a variety of locations and conditions.

As used herein, the term “sterilization” includes a range of germ-killing capability, from disinfection to complete sterilization, as needed. The term “complete sterilization” refers to rendering a substance incapable of reproduction, metabolism and/or growth. While this is often taken to mean total absence of living organisms, the term may be used herein to refer to a substance free from living organisms to a degree previously agreed to be acceptable. The previous agreement may include, for example, governmental standards for drinking water. Unless otherwise indicated, the term sterilization may be used herein to also refer to methods and procedures less rigorous than sterilization, for example, disinfection, sanitization, and the like. These may be used in commercial and industrial applications where sterilization, disinfection, sanitization, decontamination, cleaning, and the like, may be desired. Thus, while the term “sterilization” is used herein, it includes processes in which the water is treated to a level that meets the required standard. As will be apparent, by adjusting the temperature and pressure in the heating section of the apparatus, more or less sterilization may be obtained. The primary intent is to kill disease-causing pathogens at least to the extent that the water is safe for human consumption with respect to such pathogens.

The water purification apparatus in accordance with various embodiments of the present invention is configured to receive waste water containing a level of suspended solids at which the water is cloudy and/or is unpalatable due to the solids. This apparatus comprises a main tube made of a heat-resistant or heat-tolerant material, such as metal or high temperature-resistant plastic. Within the main tube, a first section contains a centrifuge and a second section contains a dynamic heat generator. In various embodiments, the dynamic heat generator heats the water sufficiently for disinfection and/or sterilization of the water. The centrifuge is intended to remove, via centrifugation, substantially all of the suspended solids in the water. The apparatus comprises a shaft that is rotated by an external source of rotational energy, such as an internal combustion engine, an electric motor, a windmill, or some other dynamic source of rotational energy. The shaft simultaneously operates both the centrifuge section and the dynamic heating section. The centrifuge section of the apparatus rotates at the same speed and direction as that of the external source of the shaft rotation. The external wall of the heater section of the tube is stationary, the discs within the dynamic heat generator rotate, and this rotation heats the water. In one embodiment, the dynamic heat generator is configured as a Tesla pump.

The centrifuge, in various embodiments, may be in the form of a rotating drum comprising three chambers. The drum is fixed to the rotating shaft.

In one embodiment, the main tube or a portion thereof is contained within an enclosure that directs hot exhaust gases from an internal combustion engine to provide heat to the system. In one embodiment, a heat exchanger or exhaust gas jacket is provided around the heating section only. In one embodiment, the incoming impure water is pre-heated in a heat exchanger using heat from the exhaust gases thereby to improve efficiency.

In one embodiment, raw water is pumped into the centrifuge section by an external device (e.g., a pump) or by gravity. This water fills the centrifuge's outer chamber and is allowed to flow out the passages machined near the outer diameter of chamber's inner wall. Once inside the main chamber, centrifugal action forces the water and the suspended solids to the outer wall of the centrifuge. Due to the difference in density between the water and the solids suspended within it, the solids are pushed to the inside of the outer centrifuge wall where a layer of concentrated solids, in one embodiment, a mixture like a slurry, is formed. The forces created by the rapidly spinning centrifuge cause the concentrated solids to flow through holes, for example, adjustable orifices or slits machined into the outer diameter of the drum, into a collection/removal area. The concentrated solids are collected by the outer enclosure and allowed to flow out into the environment for disposal.

Clarified water (centrifugal forces having removed the suspended solids) flows from the centrifuge through openings located near the inner diameter of the centrifuge. The location of these openings can be varied to obtain maximum efficiency. The water fills the outer chamber. Because the centrifuge is rotating, the water is still subjected to centrifugal forces. A pitot tube, whose position is adjustable, is located in the rotating flow of water. Water is forced into this tube which, under pressure, flows through a check valve to prevent backflow into the heater/sterilization section.

The heater/sterilization section includes a rotating shaft with a number of flat discs, which may be made of a suitable metal, high-temperature resistant plastic or other suitable material, affixed to it and, in some embodiments, separated by non-moving spacers. In one embodiment, through-holes are located near the inner diameter of the rotating discs, to provide for water flow through the heater-sterilization section. In one embodiment, the holes are in a selected or predetermined pattern.

Utilizing the “boundary layer” effect principle, water is accelerated from the inner diameter of the discs toward the inner diameter of the tube. Here it is redirected to the inner holes in the discs. This flow and redirection imparts energy into the water, causing the water temperature to elevate to a level that kills pathogens, to achieve disinfection and/or sterilization.

External to the assembly but plumbed to the heater section, is a product water release valve. The purpose of this valve is to prevent water within the heater section of the assembly from being released without being heated to a temperature required to kill pathogens to the desired degree of disinfection and/or sterilization. In one embodiment, the product water release valve is a two-way valve.

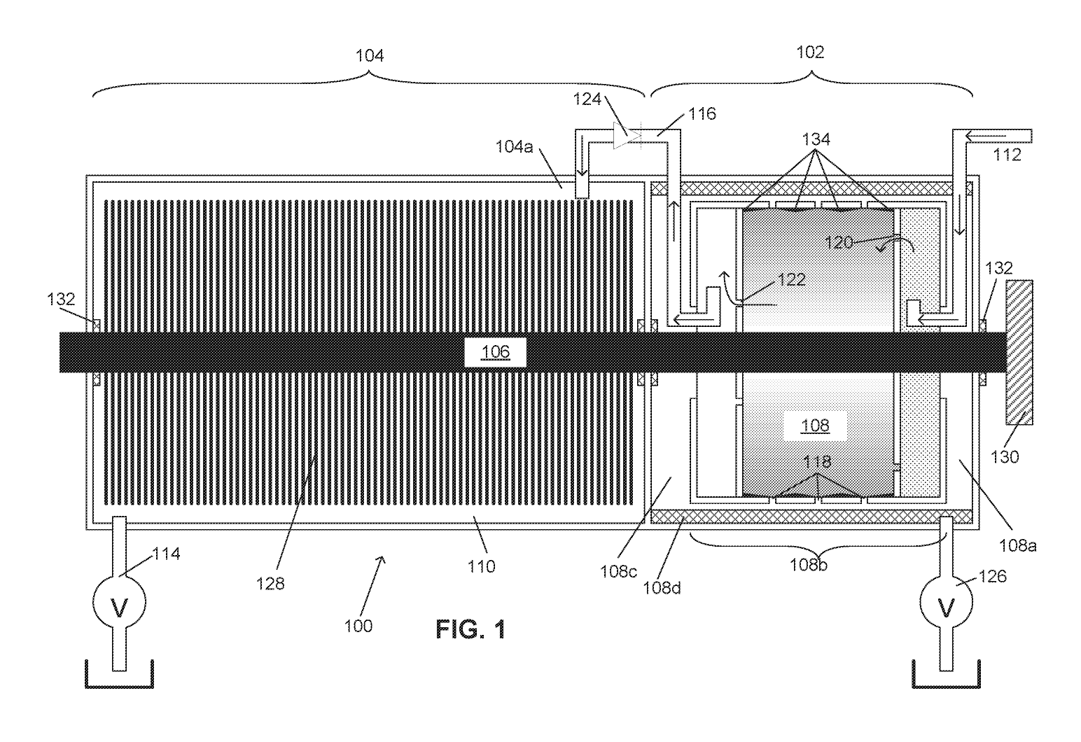

Referring now to FIG. 1, there is shown a cross-sectional view of a first embodiment of a water purification apparatus 100 according to the present invention. As shown in FIG. 1, the apparatus 100 includes a centrifuge chamber 102 and a water sterilization chamber 104. The apparatus 100 further includes a central, longitudinally extending shaft 106, upon which is mounted a centrifuge 108 and a dynamic heat generator 110. The centrifuge 108 is within the centrifuge chamber 102. The dynamic heat generator 110 is within the sterilization chamber 104.

The apparatus 100 includes an inlet 112 at the centrifuge end and a product water release valve 114 as an outlet, at the opposite end of the apparatus 100, at or near the end of the dynamic heat generator 110 of the water sterilization chamber 104. A pitot tube 116 provides fluid communication between the centrifuge 108 and the dynamic heat generator 110 section of the apparatus 100. In one embodiment, the pitot tube 116 includes a check valve 124.

The centrifuge 108 contains three sections, a first, inlet section 108a, a second, spinning, working section 108b, in which the water is spun at high speeds to generate centrifugal forces that are applied to the water in the second section 108b, and a third, outlet section 108c. The second section 108b includes one or a plurality of exit ports 118 on the outer periphery of the centrifuge, through which accumulated solids are forced to exit the centrifuge. A pump or gravity tank or other water source (not shown) is provided to the inlet 112 which in turn provides a flow of the feedwater to be treated into the first, inlet section 108a of the centrifuge 108, and then through an opening 120 located near the radially outward portion of the second section 108b of the centrifuge 108. As the centrifuge 108 spins and removes the suspended solids in the water, the cleaner water, having a reduced content of solids, moves towards the central shaft 106, while the dirtier, heavier, solids-laden water moves to the outer periphery of the second section 108b of the centrifuge 108. The cleaned water, with a reduced content of suspended solids, passes through an outlet 122 in the second section 108b of the centrifuge 108, into the third, outlet section 108c of the centrifuge 108. The outlet 122 is near the central shaft, which where the cleaner water moves under influence of the centrifugal forces generated in the centrifuge.

In FIG. 1, the first part of the second section 108b (on the right side as viewed in FIG. 1) is shown with cross-hatching to schematically illustrate that the water that is being fed to the apparatus 100 contains suspended solids. The second part of the second section 108b (in the center as viewed in FIG. 1) is illustrated with a gradation intended to schematically illustrate the separation of suspended solids which takes place in the centrifuge 108. The gradation is darker at the outer periphery, and is lighter nearer the central shaft 106, which is intended to show the differences that arise in the water as it is subjected to the centrifugation in the centrifuge 108. The third part of the second section 108b (on the left side as viewed in FIG. 1) is shown with no cross-hatching or gradation, to schematically illustrate that suspended solids have been removed and the water in this part clarified to a substantial degree in the centrifuge 108.

As shown in FIG. 1, the third, outlet section 108c of the centrifuge 108 is in fluid communication with an entry opening of the pitot tube 116. The pitot tube 116 provides fluid communication from the outlet section 108c of the centrifuge 108 to the inlet end 104a of the dynamic heat generator 110. As shown in the embodiment of FIG. 1, the pitot tube 116 includes a one-way check valve 124, to prevent water in the dynamic heat generator 110 from flowing back into the centrifuge 108. As is known in the art, a pitot tube is a component that provides passive fluid communication between chambers.

As shown in FIG. 1, in the centrifuge 108, radially outward from the spinning part of the centrifuge 108, is an outer peripheral area 108d in which spun-out solids may be collected, and from there, disposed of. As shown in FIG. 1, the collection area 108d communicates with a waste outlet 126 through which the collected solids, including some amount of dirty water, may be removed from the centrifuge 108. The solids collected are generally not dry, but are wet, possibly “muddy”, in the form of a slurry or thick suspension, including some amount of dirty water.

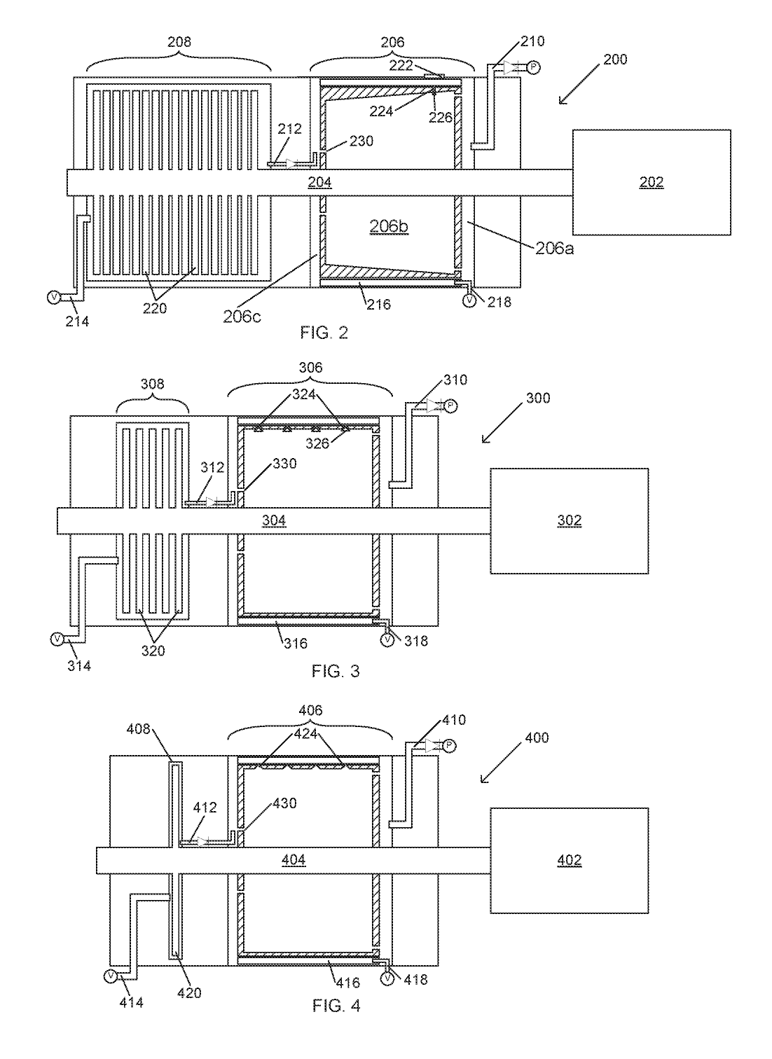

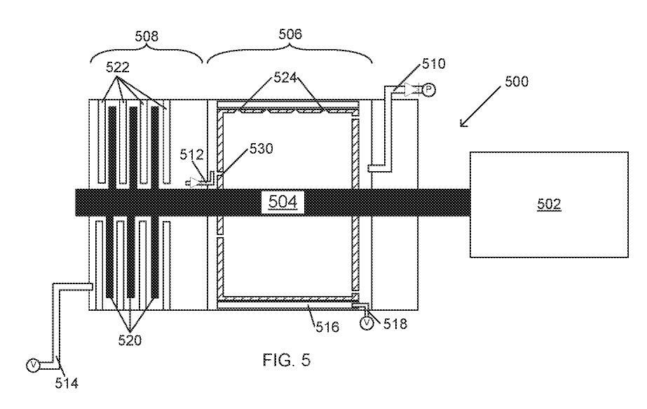

As shown in FIG. 1, in this embodiment of the present invention, the dynamic heat generator includes a large number (81) of rotating discs 128. In one embodiment, there is a single rotating disc, as shown, e.g., in FIG. 4; in one embodiment, there are 5 rotating discs, as shown, e.g., in FIG. 3. In other embodiments there may be 10 rotating discs, or essentially any number of rotating discs. In the embodiment of FIG. 1, there are 81 rotating discs 128. In one embodiment, there are 96 rotating discs. In other embodiments, there may be, for example, 64 rotating discs, 120 rotating discs, or a number of rotating discs in the range 1 to 200, or from 2 to 50, or from 2 to 20. The number of rotating discs can be suitably determined based, e.g., on the amount of water to be heated, the temperature to which the water is to be heated and the power of the motor or prime mover that rotates the discs. More water and/or higher temperature normally requires more discs, but at the same time, more discs requires a greater amount of power to rotate the discs. In one embodiment, more water and/or higher temperature may be obtained by application of a greater amount of power to obtain higher rotational speeds. It has been found that, in accordance with an embodiment of the present invention, even a single rotating disc can provide sufficient heat to sterilize a useful volume of water.

As shown in FIG. 1, the dynamic heat generator 110 includes the product water release valve 114, through which the purified water passes from the apparatus 100. The valve 114 is operated as needed to obtain the temperature and pressure desired for the disinfection or sterilization of the water in the dynamic heat generator 110 of the apparatus 100, from which the solids have been removed by the centrifuge 108. As noted, in one embodiment, the valve 114 is a two-way valve.

Referring still to the embodiment of FIG. 1, the shaft 106 is shown operably attached to a prime mover 130, which may be any suitable source of rotational energy, such as an internal combustion engine or an electric motor. The shaft 106 is mounted in the apparatus 100 on seal bearings 132, which provide both sealing and bearing functions, as known in the art.

FIG. 1 schematically illustrates accumulated solids 134, in the centrifuge 108. As these solids 134 accumulate, some will be removed via the ports 118 and will be collected in the collection area 108d, as described above.

It is noted that the reference numbers used in FIG. 1 may not correspond to the reference numbers used in FIGS. 2-5.

Referring now to FIG. 2, which is a cross-sectional view of a water purification apparatus 200 in accordance with another embodiment of the present invention, additional features in accordance with the present invention are shown and described in detail. The apparatus 200 includes a prime mover 202, e.g., a motor which is one of an electric motor, an internal combustion engine, or some other source of rotational energy configured to rotate a primary shaft 204. Mounted on the primary shaft 204 are a centrifuge unit 206 and a dynamic heating unit 208.

As shown in FIG. 2, the apparatus 200 includes a water inlet line 210, through which water to be purified is pumped from a pump P into the centrifuge chamber 206. In the embodiment shown in FIG. 2, a check valve is included in the water inlet line 210, but may not be necessary, depending on whether the water source includes a pump or other pressurized water source. The water entering the centrifuge chamber 206 from the inlet line 210 initially enters the inlet section 206a, and passes through an entry port near the outer periphery of a centrifuge main chamber 206b. In the main chamber 206b, during operation, the water is subjected to centrifugal forces which cause incoming dirty water to be separated into a solids portion and a clean portion. The suspended solids in the solids portion move toward the outer volume of the main chamber 206b, while the clean water in the clean portion is allowed to exit the main chamber 206b via a clean water exit port 230 located near the central shaft 204, into an exit chamber 206c of the centrifuge chamber 206. From the exit chamber 206c, the cleaned water enters a pitot tube 212, in this embodiment, equipped with a check valve.

As shown in FIG. 2, in this embodiment, the centrifuge chamber 206 features a sloped inner surface, which is designed and functions to direct collected solids towards a solids exit port 224, which can include a removable plug 226, and which can be accessed via an access port 222 for cleaning and/or removal of the solids. As shown in FIG. 2, the centrifuge unit 206 includes a dirty water collection reservoir 216, which operably communicates with a dirty water exit port 218, which includes a valve V for controlling flow of dirty water through the exit port 218. If the access port 222 is omitted, the solids may be removed via the exit port 218.

The cleaned water passes through the pitot tube 212 into the dynamic heating unit 208. The dynamic heating unit includes one or more rotating discs 220 which, through boundary effect dynamic heating, heat the water to the desired temperature. In the embodiment shown in FIG. 2, there are a total of 17 rotating discs, but this is merely an exemplary number. As noted, there may be as few as one single rotating disc 220, or there may be many such rotating discs 220 in a given dynamic heat chamber in other embodiments of the apparatus in accordance with the present invention. Finally, the heated water exits the dynamic heating unit 208 via an exit line 214, equipped with a flow control valve V. The valve V may be a two-way valve, or it may be electronically controlled based on, e.g., the temperature to which the water has been heated in the dynamic heating unit 208. In various embodiments of the present invention, and in accordance therewith, the water exiting through the line 214 is substantially free of suspended solids, and is substantially free of disease-causing pathogens.

FIG. 3 is a cross-sectional view of an apparatus 300 in accordance with still another embodiment of the present invention. Reference numbers in FIG. 3 correspond to the reference numbers in FIG. 2, with respect to the functionality. The basic cooperation of the apparatus 300 of this embodiment is substantially the same as the embodiment illustrated and described in FIG. 2, except that the number of rotating discs 320 shown in the dynamic heating unit 308 is five, and the internal structure of the centrifuge unit 306 is different.

As shown in FIG. 3, the interior outer wall of the centrifuge unit 306 is not sloped, and includes a plurality of solids exit ports 324, each of which is equipped with a removable plug 326. As shown in FIG. 3, in this embodiment, the dynamic heating unit 308 contains five rotating discs 320 for heating the water. As noted, the number of rotating discs can be suitably selected based on the volume of water to be heated, the temperature to which the water is to be heated, and the available power unit 202, 302, 402. It is noted that, while the exit ports 324 are shown on only one side of the centrifuge unit 306, the exit ports may be distributed at any appropriate location on the outer periphery of the centrifuge unit 306.

FIG. 4 is a cross-sectional view of an apparatus 400 in accordance with yet another embodiment of the present invention. Reference numbers in FIG. 4 correspond to the reference numbers in FIGS. 2 and 3, with respect to the functionality. The basic cooperation of the apparatus 400 of this embodiment is substantially the same as the embodiment illustrated and described in FIGS. 2 and 3, except that the number of rotating discs 420 shown in the dynamic heating unit 408 is one, the internal structure of the centrifuge unit 406 is different, although it is rather similar to the centrifuge unit 306, lacking only the removable plug.

As shown in FIG. 4, the interior outer wall of the centrifuge unit 406 is not sloped, and includes a plurality of solids exit ports 424, which are not equipped with a removable plug, although they could be, as in FIG. 3. As shown in FIG. 4, in this embodiment, the dynamic heating unit 408 contains one single rotating disc 420 for heating the water. It has surprisingly been found that the single rotating disc 420 in the dynamic heat unit 408 is sufficient to heat the cleaned water to a temperature at which substantially all of the disease-causing pathogens can be killed. As noted, the number of rotating discs can be suitably selected based on the volume of water to be heated, the temperature to which the water is to be heated, and the available power unit 202, 302, 402. It is noted that, while the exit ports 424 are shown on only one side of the centrifuge unit 406, the exit ports may be distributed at any appropriate location on the outer periphery of the centrifuge unit 406.

FIG. 5 illustrates an alternative embodiment, in which the discs alternate one by one, between rotating discs 508 and non-rotating or stationary discs 522. In this embodiment, for example, a given rotating disc 508 is flanked on both sides by a non-rotating or stationary disc 522.

FIG. 5 is a cross-sectional view of an apparatus 500 in accordance with yet another embodiment of the present invention. Reference numbers in FIG. 5 generally correspond to the reference numbers in FIGS. 2-4. The basic cooperation of the parts of the apparatus 500 of this embodiment is substantially the same as the embodiments illustrated and described in FIGS. 2-4, except that the number of rotating discs 520 shown in the dynamic heating unit 508 is three, and each rotating disc 508 is flanked on each side by a stationary disc 522 that is attached to the outer wall of the dynamic heat generator 110, and each stationary disc does not rotate. By having stationary discs as well as rotating discs, the amount of shear generated in the dynamic heat generator is greater than that which would be obtained from the same number of rotating discs without the stationary discs, and thus the heating ability is correspondingly greater. The spaces between the rotating discs 508 and the adjacent stationary discs 522, as well as the relative lengths of both sets of discs, can be determined based upon the size of the overall unit, the volume of water to be processed, the temperature sought to be attained, etc., based on routine testing and adjustment of their positions. In one embodiment, the rotating discs 508 are attached to the central shaft by a toothed connection (not shown), so that rotating discs 508 can be added or removed, as needed. The toothed connection may include, for example, from two to four “teeth” on the shaft 504 separated by spaces, and each rotating disc 508 has matching spaces and teeth, so that an interlocking but removable attachment is formed between the rotating disc 508 and the shaft 504. The stationary discs may similarly be removably mounted and the apparatus may include appropriate connectors to add more stationary discs. The number of stationary discs may be adjusted as well, as determined by the skilled person based on the various factors (e.g., water source, degree of disinfection desired, etc.) mentioned elsewhere in this disclosure.

In the embodiment of FIG. 5, the internal structure of the centrifuge unit 506 is the same as that shown in FIG. 4, in that the centrifuge unit 506 lacks the removable plug 326 shown in FIG. 3.

It is specifically noted that, in the embodiments illustrated in each of FIGS. 1-5, any one of the centrifuge units shown in the Figures can be paired with any one of the dynamic heating units. Thus, the dynamic heating unit of FIG. 1 can be paired with any one of the centrifuge units shown in FIG. 2, FIG. 3, FIG. 4 or FIG. 5, or with another suitably selected centrifuge unit with combinations of the features shown in FIGS. 2-5; the dynamic heating unit 208 of FIG. 2 can be paired with any one of the centrifuge units shown in FIG. 1, FIG. 3, FIG. 4, or FIG. 5, or with another suitably selected centrifuge unit with combinations of the features shown in FIGS. 1-5; the dynamic heating unit 308 of FIG. 3 can be paired with any one of the centrifuge units shown in FIG. 1, FIG. 2, FIG. 4, or FIG. 5, or with another suitably selected centrifuge unit with combinations of the features shown in FIGS. 1-5; the dynamic heating 408 unit of FIG. 4 can be paired with any one of the centrifuge units shown in FIG. 1, FIG. 2, FIG. 3 or FIG. 5, or with another suitably selected centrifuge unit with combinations of the features shown in FIGS. 1-5, and the dynamic heating 508 unit of FIG. 5 can be paired with any one of the centrifuge units shown in FIG. 1, FIG. 2, FIG. 3 or FIG. 4, or with another suitably selected centrifuge unit with combinations of the features shown in FIGS. 1-5.

In one embodiment, the centrifuge chamber includes rifling-like grooves to facilitate movement of the collected solids towards the solids exit port.

In one embodiment, the centrifuge chamber includes paddle wheels to facilitate movement of the water through the unit, towards the clean water exit port.

In one embodiment, the water in the heating or sterilization chamber is heated to a temperature up to about 300° F. (about 149° C.), and in other embodiments, to temperatures in the range from about 212° F. (about 100° C.) to about 280° F. (about 138° C.). Any temperature up to about 300° F. (about 149° C.) can be attained, as needed. In one embodiment, the water is heated to 121° C. (249° F.) for a residence time of about 15-20 minutes, to attain sterilization similar to that attained by steam sterilization processes in, e.g., the medical arts. The water in the heating or sterilization chamber can be exposed to pressures ranging from one atmosphere (e.g., about 14.7 psi) up to about 2.5 atmospheres (about 36.7 psi). The dynamic heat generator can attain whatever temperature and pressure may be needed. As will be recognized, higher temperatures and pressures will usually require a longer residence time, or a higher energy input in the rotating shaft, which may result in lower productivity and/or higher energy costs. In addition, as will be understood, properties such as the strength and the thickness of the materials of which the various parts of the apparatus are formed should be adequate to withstand the temperatures and pressures employed in any given embodiment of the present invention. Such properties can be suitably selected by the skilled person without undue experimentation.

The present invention has been described in the foregoing in detail for various embodiments of the apparatus and method, and persons of skill in the art will readily recognize that a number of variations are possible, all of which are considered to fall within the scope of the present claims.

It is noted that, throughout the specification and claims, the numerical limits of the disclosed ranges and ratios may be combined, and are deemed to include all intervening values. Furthermore, all numerical values are deemed to be preceded by the modifier “about”, whether or not this term is specifically stated.

While the principles of the invention have been explained in relation to certain particular embodiments, and are provided for purposes of illustration, it is to be understood that various modifications thereof will become apparent to those skilled in the art upon reading the specification. Therefore, it is to be understood that the invention disclosed herein is intended to cover such modifications as fall within the scope of the appended claims. The scope of the invention is limited only by the scope of the appended claims.

1. A water treatment apparatus comprising:
a cylindrical body;
a longitudinally extending centrifuge chamber within the cylindrical body;
a longitudinally extending heating chamber within the cylindrical body;
an externally powered, longitudinally extending, radially centrally located shaft passing through the cylindrical body, and passing through the centrifuge chamber and the heating chamber;
a centrifuge within the centrifuge chamber mounted on the central shaft and configured to centrifugally rotate on the central shaft;
at least one rotating disc within the heating chamber, the rotating disc rotatably mounted on the shaft;
an inlet operably connectable to a source of water for treatment, the inlet configured to feed water into the centrifuge chamber;
a pitot tube in fluid communication with the centrifuge chamber and the heating chamber;
a product water release valve in fluid communication with the heating chamber,
wherein the water treatment apparatus is configured to receive feed water into the centrifuge chamber, to operate the centrifuge to remove solids suspended in the feed water, to pass centrifuged water via the pitot tube into the heating chamber, to dynamically heat the centrifuged water to a selected temperature and pressure, and to release purified water from the heating chamber through the product water release valve.

2. The water treatment apparatus of claim 1 wherein the centrifuge section comprises three internal sections, comprising an inlet section, a centrifuge section, and an exit section.

3. The water treatment apparatus of claim 2, wherein the centrifuge section further comprises passages providing fluid communication between the inlet section, the centrifuge section and the exit section.

4. The water treatment apparatus of claim 1 wherein the centrifuge section comprises openings in an outer peripheral portion of the centrifuge through which solids may pass.

5. The water treatment apparatus of claim 4 wherein the centrifuge section further comprises a portion in which solids may be collected.

6. The water treatment apparatus of claim 1 wherein the pitot tube comprises a check valve.

7. The water treatment apparatus of claim 1 wherein the heating section comprises from about 1 to about 200 rotating discs.

8. The water treatment apparatus of claim 1 wherein the heating section comprises from about 2 to about 20 rotating discs.

9. The water treatment apparatus of claim 1 wherein the heating section comprises from about 5 to about 17 rotating discs.

10. The water treatment apparatus of claim 1 wherein each rotating disc is flanked by at least one stationary disc on one or both sides.

11. The water treatment apparatus of claim 1 wherein the central shaft is rotated by an external power source.

12. The water treatment apparatus of claim 1 wherein the apparatus comprises a heat exchanger for preheating the feed water prior to the water being fed into the inlet.

13. The water treatment apparatus of claim 1 wherein the apparatus comprises an internal combustion engine which is operatively connected to rotate the central shaft.

14. The water treatment apparatus of claim 13 wherein exhaust from the internal combustion engine operatively communicates with a heat exchanger to heat the feed water prior to its entry into the centrifuge chamber.

15. The water treatment apparatus of claim 13 wherein exhaust from the internal combustion engine operatively communicates with a jacket surrounding the heating section to heat the water in the heating chamber.
